(19) United States
(12) Patent Application Publication
(10) Pub. No.: US 2004/0267967 A1
(43) Pub. Date: Dec. 30, 2004

(54) Method, system, and program for managing requests to a network adaptor

(75) Inventors: Parthasarathy Sarangam, Portland, OR (US); Sujoy Sen, Portland, OR (US); Nrupal R. Jani, Hillsboro, OR (US)

Correspondence Address: KONRAD RAYNES VICTOR & MANN LLP, Suite 210, 315 S. Beverly Drive, Beverly Hills, CA, 90212, US

(73) Assignee: Intel Corporation

(21) Appl. No.: 10/609,937

(22) Filed: Jun. 30, 2003

(51) Int. Cl. G06F 15/16

(52) U.S. Cl. 709/250

(57) ABSTRACT

Provided are a method, system, and program for managing requests to a network adaptor. A request to a network adaptor is received and a data structure indicating a relationship of components of a context identifier is processed to determine an available context identifier to associate with the request. The determined context identifier and the request are transmitted to the network adaptor.

### BACKGROUND OF THE INVENTION

1. Field of the Invention

The present invention relates to a method, system, and program for managing requests to a network adaptor.

2. Description of the Related Art

In a network environment, a network adaptor on a host computer, such as an Ethernet card, Fibre Channel card, etc., will receive Input/Output (I/O) requests or responses to I/O requests initiated from the host. Often, the host computer operating system includes a device driver to communicate with the network adaptor hardware to manage I/O requests to transmit over a network. Data packets received at the network adaptor would be stored in an available allocated packet buffer in the host memory. The host computer further includes a transport protocol driver to process the packets received by the network adaptor that are stored in the packet buffer, and access any I/O commands or data embedded in the packet. For instance, the transport protocol driver may implement the Transmission Control Protocol (TCP) and Internet Protocol (IP) to decode and access the payload data in the TCP/IP packets received at the network adaptor.

The device driver requires significant host processor resources to handle network transmission requests to the network adaptor. One technique to reduce the load on the host processor is the use of a TCP/IP Offload Engine (TOE) in which the TCP/IP protocol related operations are implemented in the network adaptor hardware as opposed to the device driver, thereby saving the host processor from having to perform the TCP/IP protocol related operations. The transport protocol operations include packaging data in a TCP/IP packet with a checksum and other information, and unpacking a TCP/IP packet received from over the network to access the payload or data.

Notwithstanding, there is a continued need in the art to improve the performance of the device driver and minimize device driver processing burdens on the host processor.

### BRIEF DESCRIPTION OF THE DRAWINGS

Referring now to the drawings in which like reference numbers represent corresponding parts throughout:

FIG. 1 illustrates a computing environment in which aspects of the invention are implemented;

FIG. 2 illustrates a packet architecture used with embodiments of the invention;

FIG. 3 illustrates fields that may be included in an operation descriptor in accordance with embodiments of the invention;

FIG. 4 illustrates a data structure to store information on requests sent to the network adaptor in accordance with embodiments of the invention;

FIG. 5 illustrates information that may be included in a context identifier identifying a request sent to the network adaptor in accordance with embodiments of the invention;

FIG. 6 illustrates operations performed to manage a request to the network adaptor in accordance with embodiments of the invention;

FIG. 7 illustrates operations the network adaptor performs to return information when processing a request in accordance with embodiments of the invention;

FIG. 8 illustrates information that may be included in a result operation descriptor in accordance with embodiments of the invention;

FIG. 9 illustrates operations performed to process a result from the network adaptor processing a request in accordance with embodiments of the invention;

FIGS. 10 and 11 illustrate operations performed to manage the data structures including information on requests to the network adaptor in accordance with embodiments of the invention; and

FIG. 12 illustrates an architecture that may be used with the described embodiments.

### DETAILED DESCRIPTION OF THE PREFERRED EMBODIMENTS

In the following description, reference is made to the accompanying drawings which form a part hereof and which illustrate several embodiments of the present invention. It is understood that other embodiments may be utilized and structural and operational changes may be made without departing from the scope of the present invention.

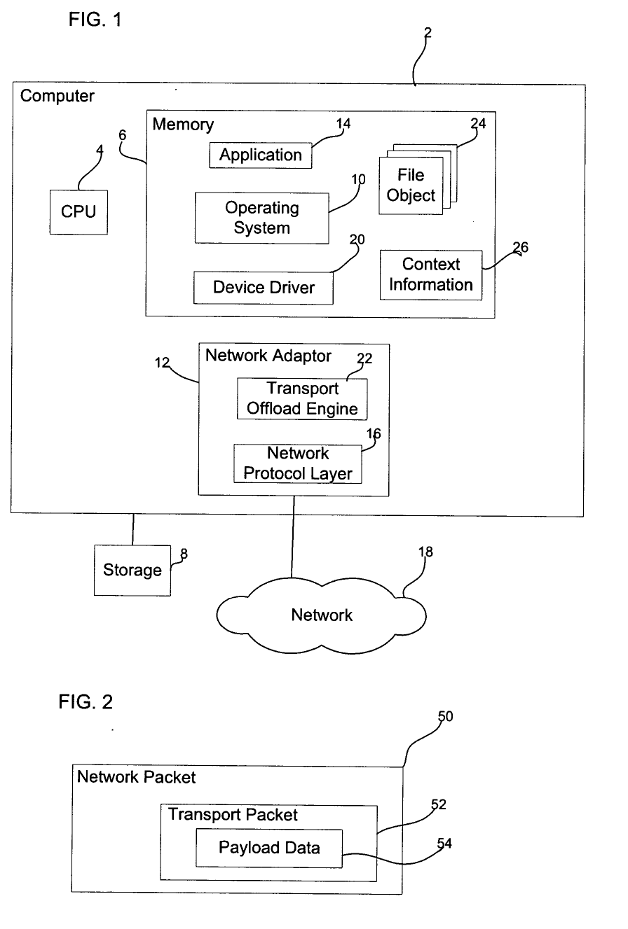

FIG. 1 illustrates a computing environment in which aspects of the invention may be implemented. A computer 2 includes one or more a central processing units (CPU) 4 (only one is shown), a volatile memory 6, non-volatile storage 8, an operating system 10, and a network adaptor 12. An application program 14 further executes in memory 6 and is capable of transmitting and receiving packets from a remote computer. The computer 2 may comprise any computing device known in the art, such as a mainframe, server, personal computer, workstation, laptop, handheld computer, telephony device, network appliance, virtualization device, storage controller, etc. Any CPU 4 and operating system 10 known in the art may be used. Programs and data in memory 6 may be swapped into storage 8 as part of memory management operations.

The network adaptor 12 includes a network protocol layer 16 for implementing the physical communication layer to send and receive network packets to and from remote devices over a network 18. The network 18 may comprise a Local Area Network (LAN), the Internet, a Wide Area Network (WAN), Storage Area Network (SAN), a wireless network, etc. In certain embodiments, the network adaptor 12 and network protocol layer 16 may implement the Ethernet protocol, token ring protocol, Fibre Channel protocol, Infiniband, Serial Advanced Technology Attachment (SATA), parallel SCSI, serial attached SCSI cable, etc., or any other network communication protocol known in the art.

A device driver 20 executes in memory 6 and includes network adaptor 12 specific commands to communicate with the network adaptor 12 and interface between the operating system 10 and the network adaptor 12.

In certain implementations, the network adaptor 12 includes a transport offload engine 22 as well as the network protocol layer 16. In this way, the network adaptor 12 implements a TCP/IP offload engine (TOE), in which the transport layer operations are performed within the transport offload engine 22 implemented within the network adaptor 12 hardware, as opposed to the device driver 20. The transport offload engine 22 interfaces with the device driver 20 and performs transport protocol layer operations, such as processing the content of messages included in the packets received at the network adaptor 12 that are wrapped in a transport layer, such as TCP and/or IP, the Internet Small Computer System Interface (iSCSI), Fibre Channel SCSI, parallel SCSI transport, or any other transport layer protocol known in the art. The network layer 16 handles network communication and provides received TCP/IP packets to the transport protocol layer 22. The transport offload engine layer 22 would unpack the payload from the received TCP/IP packet and transfer the data to the device driver 20 to return to the application 14. Further, an application 14 transmitting data would transmit the data to the device driver 20, which would then send to the transport offload engine 22 to package in a TCP/IP packet before transmitting over the network 18 through the network protocol layer 16.

The memory 6 further includes file objects 24, which also may be referred to as socket objects, which include information on a connection to a remote computer over the network 18. The application 14 uses the information in the file object 24 to identify the connection. The application 14 would use the file object 24 to communicate with a remote system. The file object 24 may indicate the local port or socket that will be used to communicate with a remote system, a local network (IP) address of the computer 2 in which the application 14 executes, how much data has been sent and received by the application 14, and the remote port and network address, e.g., IP address, with which the application 14 communicates. Context information 26 comprises a data structure including information the device driver 20 maintains to manage requests sent to the network adaptor 12 as described below.

FIG. 2 illustrates a format of a network packet 50 received at the network adaptor 12. The network packet 50 is implemented in a format understood by the network protocol 14, such as an Ethernet packet that would include additional Ethernet components, such as a header and error checking code (not shown). A transport packet 52 is included in the network packet 50. The transport packet may 52 comprise a transport layer capable of being processed by the transport protocol driver 22, such as the TCP and/or IP protocol, Internet Small Computer System Interface (iSCSI) protocol, Fibre Channel SCSI, parallel SCSI transport, etc. The transport packet 52 includes payload data 54 as well as other transport layer fields, such as a header and an error checking code. The payload data 52 includes the underlying content being transmitted, e.g., commands, status and/or data. The operating system 10 may include a device layer, such as a SCSI driver (not shown), to process the content of the payload data 54 and access any status, commands and/or data therein.

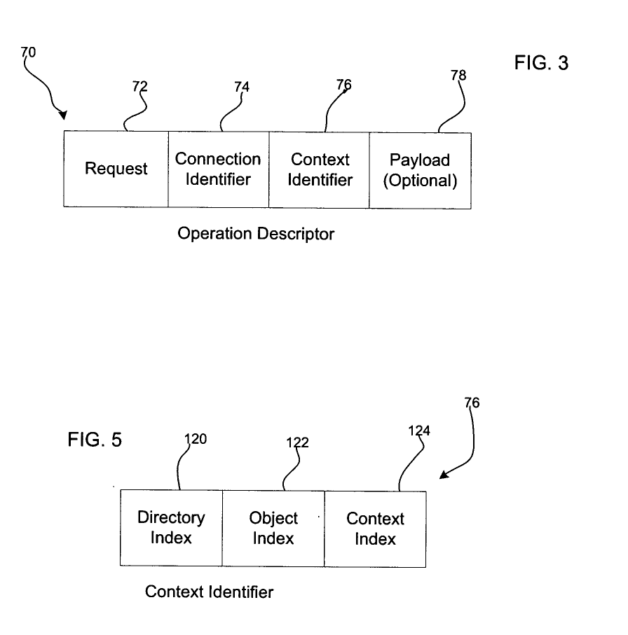

In certain implementations, the device driver 20 would transmit requests to the network adaptor 12 in the form of an operation descriptor. Such requests included in the operation descriptor may include a request to establish a connection, send and receive data, fetch statistics, etc. FIG. 3 illustrates an operation descriptor 70 as including:

request 72: indicates the type of request, such as to establish a connection, send data, request statistical information, etc.

connection identifier 74: identifies information on the network connection to which the request is directed, which may comprise the socket identifier or file object 24, which the operating system 10 uses to provide information on the connection to which the request is directed

context identifier 76: identifies one request sent to the network adaptor 12. The context identifier 76 is used to identify the task communicated to the network adaptor 12 to implement the request 72 that is the subject of the operation descriptor 70.

payload 78: if the request is to transmit data, then the payload 78 includes the data to transmit.

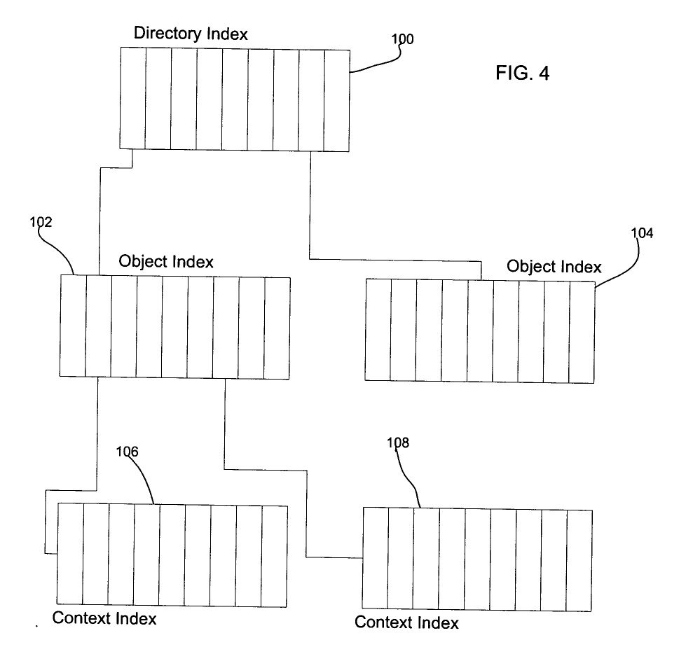

In described implementations, the device driver 20 maintains the context identifier 76 information representing requests sent to the network adaptor 12 in a tree data structure implementing the context information 26 that is indexed according to the fields in the context identifier 76. FIG. 4 illustrates how the context information 26 is organized. A directory index 100 includes entries, where each entry provides an index to an object index 102 and 104. Each object index 102, 104 includes multiple entries, where each entry identifies one file object 24 representing a connection that is subject to an operation request. Each object index 102, 104 entry is associated with one context index 106, 108, respectively. The context indices 106, 108 have multiple entries, where each entry provides information on a specific request that is the subject of an operation descriptor 70 transmitted to the network adaptor 12. The context information maintained in the context index 106, 108 entry may indicate the status of the operation identified by the context identifier 76 (FIG. 2), such as completed, pending, failed, etc.

FIG. 5 illustrates the fields in the context identifier 76 that are used to reference the operation request transmitted as part of an operation descriptor 70:

directory index 120: provides an index to one entry in the directory index 100 (FIG. 4).

Object index 122: provides an index to an entry in the object index 102, 104 addressed by the directory index 100 entry identified in the directory index 120 field.

Context index 124: provides an index to an entry in the context index 106, 108 addressed by the entry identified in the object index 122 field. In this way, multiple operations, each identified by a separate entry in the context index 106, 108, are associated with one object index entry, that identifies a file object 24 and connection used by one application 4.

Thus, for a new network transmission request encapsulated in an object descriptor 70, the device driver 20 will update the context information 26 by adding a context index entry to one context index 106, 108 associated with an object index 102, 104 entry representing the connection to which the request is directed. In certain implementations, the context identifier 76 may comprise a 32 bit value, where the first eight bits comprises the directory index 120, the second ten bits comprises the object index 122, and the remaining twelve bits comprises the context index 124. The device driver 20 would assign a unique context identifier 76 to each request transmitted to the network adaptor 12.

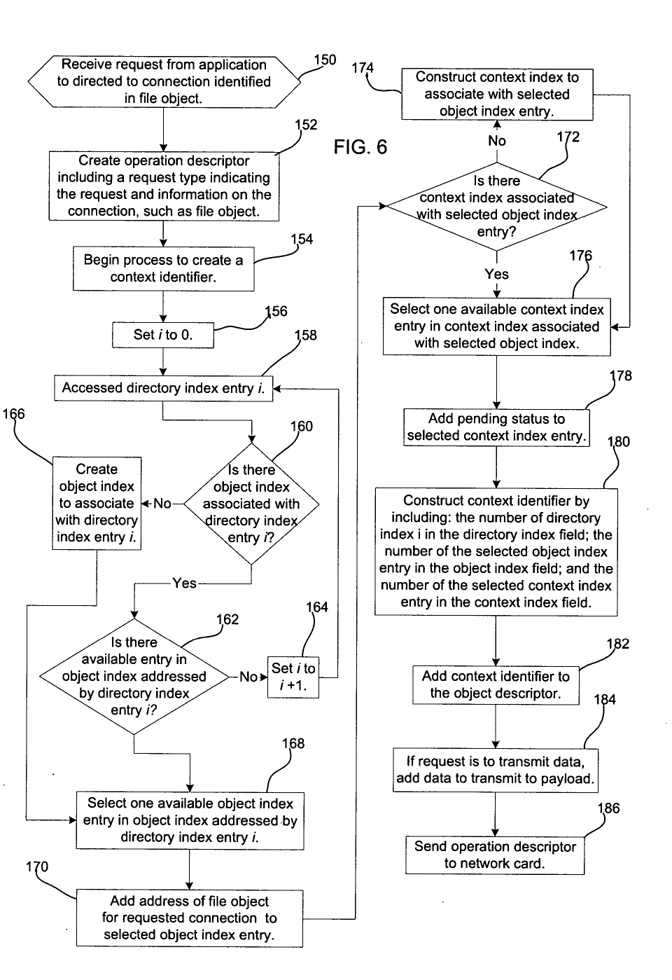

FIG. 6 illustrates operations performed by the device driver 20 to update the context information 26 with information on a new request for the network adaptor 12 from an application 14 or the operating system 10. Upon receiving (at block 150) a request from the application 14 or operating system 10 directed to a connection represented by a file object 24, the device driver 20 creates (at block 152) an operation descriptor 70 (FIG. 3) including a request field 72 indicating the request and a connection identifier 74, which may identify the location of the file object 24 representing the connection to which the request is directed. As discussed, the request may comprise a request to open or establish a connection, transmit a payload, obtain statistical information, etc. At block 154, the process begins to create the context identifier 76, which extends through step 180. The variable i is set (at block 156) to 0 and the directory index 120 entry i is accessed (at block 158). If (at block 160) there is an object index 102, 014 associated with the directory index 120 entry i, then the device driver 20 determines (at block 162) whether there is an available entry in the object index 102, 104 addressed by directory index entry i. If (at block 162) there are no further available object index entries in the object index associated with directory index i, then i is incremented (at block 164) by one and control proceeds back to block 158 to consider the next directory index entry i. If (at block 160) there is no object index 102, 014 associated with directory index entry i, then the device driver 20 creates (at block 166) an object index 102, 104 to associate with directory index entry i. When there is an available object index entry in the object index associated with directory index entry i (from block 164 or block 166), the device driver 20 selects (at block 168) one available object index 102, 014 entry in the object index associated with directory index entry i, which may be the first available entry in the object index. The device driver 20 then adds (at block 170) the address of the file object 24 representing the connection, to which the request is directed, to the selected object index 102, 104 entry.

If (at block 172) there is no context index 106, 108 associated with the selected object index 102, 104 entry, then the device driver 20 constructs (at block 174) a new context index 106, 108 to associate with the selected object index entry. Once a context index 106, 108 is associated with the selected object index entry (from the no branch of block 172 or block 174), the device driver 20 selects (at block 176) one available context index entry in the context index 106, 108 associated with selected object index 102, 104 entry and adds (at block 178) a pending status to the selected context index entry to indicate that the operation associated with the created context index identifier is pending. The selected context index entry may comprise a context index entry having a status indicated as completed.

The device driver 20 may then construct (at block 180) a context identifier 76 (FIG. 5) by concatenating: the number of directory index i in the directory index field 120; the number of the selected object index entry in the object index field 122; and the number of the selected context index entry in the context index field 124. The constructed context identifier is then added (at block 182) fo field 76 in the object descriptor 70 (FIG. 3). If (at block 184) the request is to transmit data, then the payload to transmit is added to field 78 of the operation descriptor 70. The device driver 20 then sends (at block 186) the constructed object descriptor 70 to the network adaptor 12.

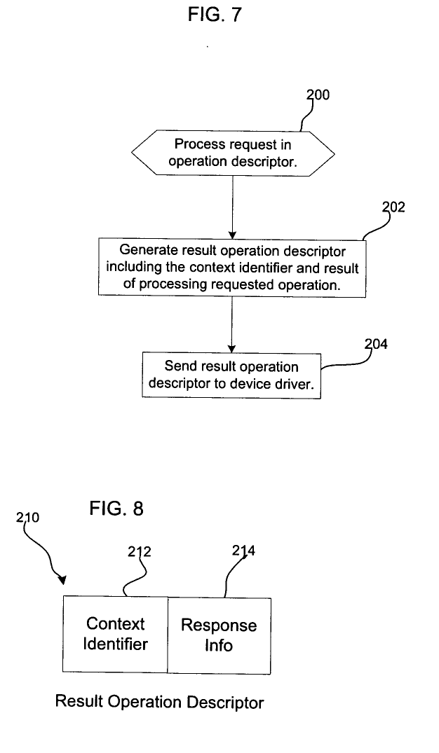

FIG. 7 illustrates operations performed within the hardware of the network adaptor 12, such as the transport offload engine 22 and other components. The transport offload engine 22 hardware would process (at block 200) the operation descriptor 70 (FIG. 3) and perform the requested operation with respect to the connection identified in the connection identifier 74, which may involve establishing a connection with a remote system, transmitting data, etc. After completing the operation, the transport offload engine 22 would generate (at block 202) a result operation descriptor. FIG. 8 illustrates the information that may be included in a result operation descriptor 210 including the context identifier 212 included in the operation descriptor 70 from the device driver 20 which included the processed request and result information 214 on the result of processing the requested operation. The transport offload engine 22 would transmit (at block 204) the result operation descriptor 210 to the device driver 20. The result may indicate that the operation successfully completed or that the operation failed. If the requested operation failed, then the result operation descriptor may provide reasons for the failure, such as an error code.

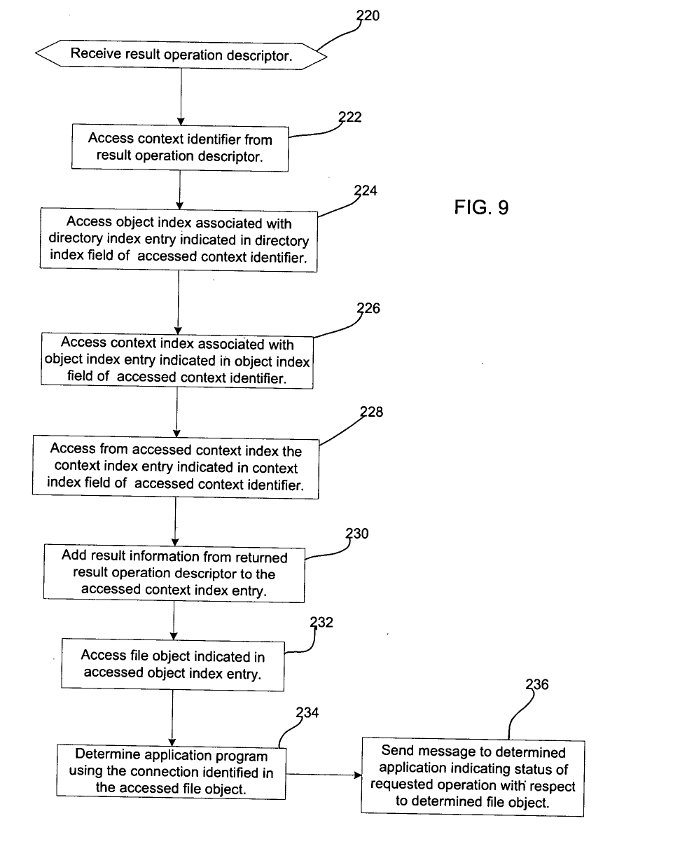

FIG. 9 illustrates operations performed by the device driver 20 to process a result operation descriptor 210 received from the network adaptor 12. Upon receiving (at block 220) the result operation descriptor 210, the device driver 20 accesses (at block 222) the context identifier 212 from the result operation descriptor 210. The device driver 20 then goes to the context information 26 tree data structure (FIG. 4) and accesses (at block 224) the object index 102, 104 associated with directory index 100 (FIG. 4) entry indicated in the directory index 120 (FIG. 5) field of the accessed context identifier 210. The device driver 20 then accesses (at block 226) the context index 106, 108 associated with object index 102, 104 entry indicated in the object index field 122 of the accessed context identifier 212. The device driver 20 then accesses (at block 228) from the accessed context index 106, 108 the context index entry indicated in the context index field 124 of the accessed context identifier 212 and adds (at block 230) result information from the result information 214 in the returned result operation descriptor 210 to the accessed context index entry. In this way, the device driver 20 may access information on a transmitted operation descriptor 70 request with three accesses: one access to the object index associated with the directory index entry identified in the context identifier; a second access to the context identifier entry identified in the object index identified in the context identifier; and a third access of the context index entry identified in the context identifier in the accessed context index.

The device driver 20 may further access (at block 232) the file object 24 indicated in the accessed object index 102, 104 entry and determine (at block 234) from the accessed file object 24 the application program 14 using the connection identified in the accessed file object 24. A message is then sent (at block 236) to the determined application 14 indicating the status of the requested operation with respect to the connection represented by the determined file object 24.

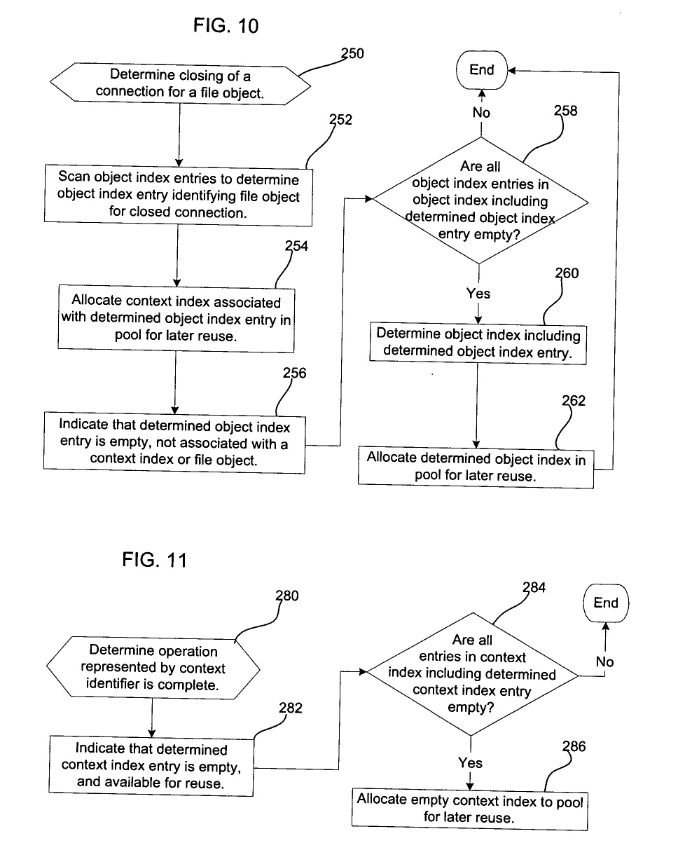

FIGS. 10 and 11 illustrate operations the device driver 20 performs to clean-up and otherwise optimize the use of memory 6 space storing the context information 26. With respect to FIG. 10, upon determining (at block 250) the closing of a connection represented by a file object 26, the device driver 20 scans (at block 252) the object index 102, 104 entries to determine the object index entry identifying the file object 26 representing the closed connection. The device driver 20 then moves (at block 254) the context index 106, 108 data structure associated with the determined object index entry to a memory pool for later reuse as a new context index when the device driver 20 creates a context index 106, 108 at block 174 in FIG. 6. In this way, the device driver 20 does not need to allocate new memory 6 for a new context index, but just reuse an unused/previously released context index allocated in memory 6. The determined object index entry is indicated (at block 256) as empty or NULL. If (at block 258) all the object index entries in the object index 102, 104 including the determined object index entry are empty or NULL, i.e., not used to identify a file object 26 representing an active connection, then the device driver 20 determines (at block 260) the object index 102, 104 and allocates (at block 262) the determined object index to a memory pool for later reuse/allocation when a new object index 102, 104 is constructed at block 166 in FIG. 6.

With respect to FIG. 11, upon determining (at block 280) that an operation represented by context identifier is complete, the device driver 20 indicates (at block 282) that the determined context index entry is empty, and available for reuse. If (at block 284) all entries in the context index 106, 108 including the determined context index entry are empty, then the empty context index 106, 108 is allocated (at block 286) to the memory pool for later reuse. In this way, the device driver 20 does not need to allocate new memory 6 for a new context index, but just reuse an free context index allocated in a memory 6 pool.

With the described implementations, the device driver 20 can manage requests sent to the network card 12 using a tree structure including an arrangement of the elements of a context identifier in manner that conserves the use of memory space by having nodes of the tree data structure store information for multiple context identifiers which correspond to multiple requests sent to the network card 12. The described context information 26 tree data structure provides for optimized use of memory and faster searching for information on a submitted request identified by a context identifier by only requiring a few lookup operations and eliminating searches to locate the information for a specific request identified by a context identifier. Moreover, the described embodiments need only allocate a small number of entries initially to the tree data structure and dynamically increase the entries as the number of connections grows thereby minimizing the up-front memory requirements on the driver.

### Additional Embodiment Details

The described techniques for processing requests directed to a network card may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

In the described embodiments, certain operations were described as being performed by the device driver 20 and transport offload engine 22. In alterative embodiments, operations described as performed by the device driver 20 may be performed by the transport offload engine 22, and vice versa.

In the described implementations, the transport protocol layer was implemented in the network adaptor 12 hardware. In alternative implementations, the transport protocol layer may be implemented in the device driver or host memory 6, and the device driver 20 would use the context information 26 to manage requests transmitted to the network adaptor 12.

In the described embodiments, the packets are received at a network adaptor card from a remote computer over a network. In alternative embodiments, the transmitted and received packets processed by the transport protocol layer or device driver may be received from a separate process executing in the same computer in which the device driver and transport protocol driver execute. In such embodiments, the network card is not used as the packets are passed between processes within the same computer and/or operating system.

In certain implementations, the device driver and network adaptor embodiments may be included in a computer system including a storage controller, such as a SCSI, Integrated Drive Electronics (IDE), Redundant Array of Independent Disk (RAID), etc., controller, that manages access to a non-volatile storage device, such as a magnetic disk drive, tape media, optical disk, etc. In alternative implementations, the network adaptor embodiments may be included in a system that does not include a storage controller, such as certain hubs and switches.

In certain implementations, the device driver and network adaptor embodiments may be implemented in a computer system including a video controller to render information to display on a monitor coupled to the computer system including the device driver and network adaptor, such as a computer system comprising a desktop, workstation, server, mainframe, laptop, handheld computer, etc. Alternatively, the network adaptor and device driver embodiments may be implemented in a computing device that does not include a video controller, such as a switch, router, etc.

In certain implementations, the network adaptor may be configured to transmit data across a cable connected to a port on the network adaptor. Alternatively, the network adaptor embodiments may be configured to transmit data over a wireless network or connection, such as wireless LAN, Bluetooth, etc.

FIGS. 3, 5, and 8 illustrate information included in an operation descriptor, context identifier, and result operation descriptor, respectively, In alternative implementation, these data structures may include additional or different information than illustrated in the figures.

FIG. 4 illustrates a tree data structure for storing information within context identifiers representing requests transmitted to a network card. In alternative implementations, alternative data structures, including different tree arrangements or non-tree data structures, may be used to store context identifier information.

The illustrated logic of FIGS. 6, 9, 10, and 11 show certain events occurring in a certain order. In alternative embodiments, certain operations may be performed in a different order, modified or removed. Morever, steps may be added to the above described logic and still conform to the described embodiments. Further, operations described herein may occur sequentially or certain operations may be processed in parallel. Yet further, operations may be performed by a single processing unit or by distributed processing units.

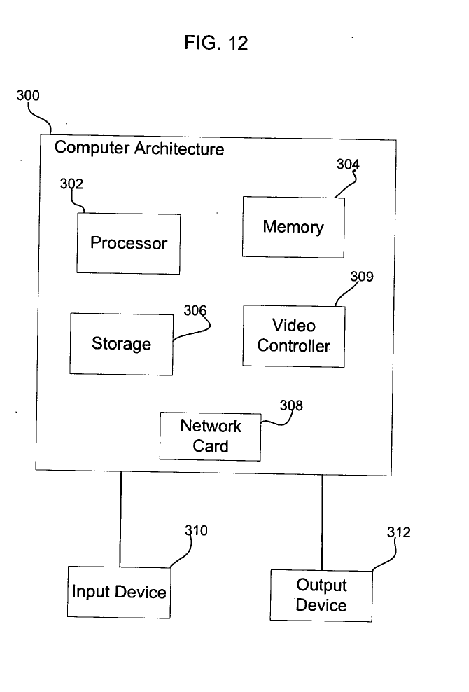

FIG. 12 illustrates one implementation of a computer architecture 300 of the network components, such as the hosts and storage devices shown in FIGS. 1, 2, and 3. The architecture 300 may include a processor 302 (e.g., a microprocessor), a memory 304 (e.g., a volatile memory device), and storage 306 (e.g., a non-volatile storage, such as magnetic disk drives, optical disk drives, a tape drive, etc.). The storage 306 may comprise an internal storage device or an attached or network accessible storage. Programs in the storage 306 are loaded into the memory 304 and executed by the processor 302 in a manner known in the art. The architecture further includes a network card 308 to enable communication with a network, such as an Ethernet, a Fibre Channel Arbitrated Loop, etc. Further, the architecture may, in certain embodiments, include a video controller 309 to render information on a display monitor, where the video controller 309 may be implemented on a video card or integrated on integrated circuit components mounted on the motherboard. As discussed, certain of the network devices may have multiple network cards. An input device 310 is used to provide user input to the processor 302, and may include a keyboard, mouse, pen-stylus, microphone, touch sensitive display screen, or any other activation or input mechanism known in the art. An output device 312 is capable of rendering information transmitted from the processor 302, or other component, such as a display monitor, printer, storage, etc.

The network adaptor 12, 308 may be implemented on a network card, such as a Peripheral Component Interconnect (PCI) card or some other I/O card, or on integrated circuit components mounted on the motherboard.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for managing requests to a network adaptor, comprising:
receiving a request to a network adaptor;
processing a data structure indicating a relationship of components of a context identifier to determine an available context identifier to associate with the request; and
transmitting the determined context identifier and the request to the network adaptor.

2. The method of claim 1, further comprising:
updating an entry in the data structure associated with the determined context identifier to include information on the request.

3. The method of claim 1, wherein the context identifier components include an object index and a context index, wherein the data structure relates at least one object index having entries, wherein each object index entry is capable of indicating one context index having entries, wherein the determined context identifier includes a value for one object index entry and a value for one context index entry.

4. The method of claim 3, further comprising:
receiving a context identifier;
determine from the data structure one object index;
determining from the data structure the object index entry in the determined object index corresponding to the object index entry value included in the received context identifier;
determining the context index associated with the determined object index entry; and
determining from the data structure the context index entry in the determined context index corresponding to the context index entry value included in the received context identifier.

5. The method of claim 4, wherein the context identifier is received with a response from the network adaptor, further comprising:
updating the determined context index entry to include information in the response from the network adaptor.

6. The method of claim 3, wherein the data structure further includes a directory index having entries, wherein at least one directory index entry is associated with one object index, and wherein the determined context identifier further includes a value for one directory index entry associated with one object index.

7. The method of claim 6, further comprising:
receiving a context identifier;
determining from the data structure the object index indicated in the directory index entry corresponding to the directory index value in the received context identifier;
determining from the data structure the object index entry in the determined object index corresponding to the object index entry value included in the received context identifier;
determining the context index indicated in the determined object index entry; and
determining from the data structure the context index entry in the determined context index corresponding to the context index entry value included in the received context identifier.

8. The method of claim 3, wherein the object index entry identifies a connection object representing one connection to a remote system, and wherein each object index entry including information on one connection may be associated with multiple context index entries, wherein each context index entry associated with one object index entry identifies one request transmitted to the network adaptor.

9. The method of claim 8, wherein the connection object identifies an application program that initiated the request, further comprising:
receiving a response from the network adaptor for a context identifier;
determining the connection object identified in the object index indicated in the object index component of the context identifier;
determining the application program that initiated the request from the connection object; and
returning a response to the application program providing information from the response received from the network adaptor for the request associated with the context identifier included in the response from the network adaptor.

10. The method of claim 8, further comprising:
determining that a connection represented by one connection object has terminated;
determining the object index entry in the data structure associated with the connection object representing the terminated connection; and
allocating as available for reuse the context index associated with the determined object index entry.

11. The method of claim 10, further comprising:
if the object index including the determined object index entry has no entry associated with an active connection, then allocating as available for reuse the object index including the determined object index entry.

12. A system in communication with data storage, comprising:
a system memory;
a processor coupled to the system memory;
a network adaptor;
a data storage controller for managing Input/Output (I/O) access to the data storage; and
a data structure in the memory including a relationship of components of a context identifier, wherein each context identifier represents one request submitted to the network adaptor; and
a device driver executable by the processor in the memory, wherein the executable device driver comprises instructions to:
(i) receive a request for the network adaptor;
(ii) process the data structure to determine an available context identifier to associate with the request; and
(iii) cause the transmittal the determined context identifier and the request to the network adaptor.

13. The method of claim 12, wherein the data storage comprises a magnetic storage medium.

14. The system of claim 12, wherein the executable device driver further comprises instructions to:
updating an entry in the data structure associated with the determined context identifier to include information on the request.

15. The system of claim 12, wherein the context identifier components include an object index and a context index, wherein the data structure relates at least one object index having entries, wherein each object index entry is capable of indicating one context index having entries, wherein the determined context identifier includes a value for one object index entry and a value for one context index entry.

16. The system of claim 15, wherein the executable device driver further comprises instructions to:
receive a context identifier;
determine from the data structure one object index;
determine from the data structure the object index entry in the determined object index corresponding to the object index entry value included in the received context identifier;
determine the context index associated with the determined object index entry; and
determine from the data structure the context index entry in the determined context index corresponding to the context index entry value included in the received context identifier.

17. The system of claim 15, wherein the context identifier is received with a response from the network adaptor, wherein the executable device driver further comprises instructions to:
update the determined context index entry to include information in the response from the network adaptor.

18. The system of claim 15, wherein the data structure further includes a directory index having entries, wherein at least one directory index entry is associated with one object index, and wherein the determined context identifier further includes a value for one directory index entry associated with one object index.

19. The system of claim 18, wherein the executable device driver further comprises instructions to:
receive a context identifier;
determine from the data structure the object index indicated in the directory index entry corresponding to the directory index value in the received context identifier;
determine from the data structure the object index entry in the determined object index corresponding to the object index entry value included in the received context identifier;
determine the context index indicated in the determined object index entry; and
determine from the data structure the context index entry in the determined context index corresponding to the context index entry value included in the received context identifier.

20. The system of claim 15, wherein the object index entry identifies a connection object representing one connection to a remote system, and wherein each object index entry including information on one connection may be associated with multiple context index entries, wherein each context index entry associated with one object index entry identifies one request transmitted to the network adaptor.

21. The system of claim 20, wherein the connection object identifies an application program that initiated the request, wherein the executable device driver further comprises instructions to:
receive a response from the network adaptor for a context identifier;
determine the connection object identified in the object index indicated in the object index component of the context identifier;
determine the application program that initiated the request from the connection object; and
return a response to the application program providing information from the response received from the network adaptor for the request associated with the context identifier included in the response from the network adaptor.

22. The system of claim 20, wherein the executable device driver further comprises instructions to:
determine that a connection represented by one connection object has terminated;
determine the object index entry in the data structure associated with the connection object representing the terminated connection; and
allocate as available for reuse the context index associated with the determined object index entry.

23. The system of claim 22, wherein the executable device driver further comprises instructions to:
if the object index including the determined object index entry has no entry associated with an active connection, then allocate as available for reuse the object index including the determined object index entry.

24. An article of manufacture for managing requests to a network adaptor, wherein the article of manufacture causes operations to be performed, the operations comprising:
receiving a request to a network adaptor;
processing a data structure indicating a relationship of components of a context identifier to determine an available context identifier to associate with the request; and
transmitting the determined context identifier and the request to the network adaptor.

25. The article of manufacture of claim 24, wherein the operations further comprise:
updating an entry in the data structure associated with the determined context identifier to include information on the request.

26. The article of manufacture of claim 24, wherein the context identifier components include an object index and a context index, wherein the data structure relates at least one object index having entries, wherein each object index entry is capable of indicating one context index having entries, wherein the determined context identifier includes a value for one object index entry and a value for one context index entry.

27. The article of manufacture of claim 26, wherein the operations further comprise:
receiving a context identifier;
determine from the data structure one object index;
determining from the data structure the object index entry in the determined object index corresponding to the object index entry value included in the received context identifier;
determining the context index associated with the determined object index entry; and
determining from the data structure the context index entry in the determined context index corresponding to the context index entry value included in the received context identifier.

28. The article of manufacture of claim 27, wherein the context identifier is received with a response from the network adaptor, wherein the operations further comprise:
updating the determined context index entry to include information in the response from the network adaptor.

29. The article of manufacture of claim 26, wherein the data structure further includes a directory index having entries, wherein at least one directory index entry is associated with one object index, and wherein the determined context identifier further includes a value for one directory index entry associated with one object index.

30. The article of manufacture of claim 29, wherein the operations further comprise:
receiving a context identifier;
determining from the data structure the object index indicated in the directory index entry corresponding to the directory index value in the received context identifier;
determining from the data structure the object index entry in the determined object index corresponding to the object index entry value included in the received context identifier;
determining the context index indicated in the determined object index entry; and
determining from the data structure the context index entry in the determined context index corresponding to the context index entry value included in the received context identifier.

31. The article of manufacture of claim 26, wherein the object index entry identifies a connection object representing one connection to a remote system, and wherein each object index entry including information on one connection may be associated with multiple context index entries, wherein each context index entry associated with one object index entry identifies one request transmitted to the network adaptor.

32. The article of manufacture of claim 31, wherein the connection object identifies an application program that initiated the request, wherein the operations further comprise:
receiving a response from the network adaptor for a context identifier;
determining the connection object identified in the object index indicated in the object index component of the context identifier;
determining the application program that initiated the request from the connection object; and
returning a response to the application program providing information from the response received from the network adaptor for the request associated with the context identifier included in the response from the network adaptor.

33. The article of manufacture of claim 31, wherein the operations further comprise:
determining that a connection represented by one connection object has terminated;
determining the object index entry in the data structure associated with the connection object representing the terminated connection; and
allocating as available for reuse the context index associated with the determined object index entry.

34. The article of manufacture of claim 33, wherein the operations further comprise:
if the object index including the determined object index entry has no entry associated with an active connection, then allocating as available for reuse the object index including the determined object index entry.
